(19) United States
(12) Patent Application Publication
(10) Pub. No.: US 2004/0117549 A1
(43) Pub. Date: Jun. 17, 2004

(54) Control method for distributed storage system

(75) Inventor: Tomohiro Nakamura, Hachioji (JP)

Correspondence Address: Stanley P. Fisher, Reed Smith LLP, Suite 1400, 3110 Fairview Park Drive, Falls Church, VA, 22042-4503, US

(73) Assignee: Hitachi Ltd.

(21) Appl. No.: 10/374,095

(22) Filed: Feb. 27, 2003

(30) Foreign Application Priority Data
Dec. 13, 2002 (JP) P2002-361606

(51) Int. Cl. G06F 12/16

(52) U.S. Cl. 711/114; 711/162

(57) ABSTRACT

A control method for a distributed data storage is described. In one example, the method includes loading data at high speed and avoiding massive increases in data transfer time due to redundancy while maintaining high reliability through a redundant system. The method includes maintaining the distributed storage system at a high reliability through dual redundant data storage when storing data into multiple storage units. When loading data from multiple storage units, the method includes restoring all data based on the arriving redundant data without waiting for transfer of the remaining data at the point where either of the redundant data is usually acquired, to achieve high speed data loading.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention generally relates to a distributed storage system and, more particularly, to a control method for a distributed storage system for storing dual-redundant data to ensure both the reliability of each storage unit and the reliability of the overall distributed storage system.

2. Discussion of Background

Disk array devices are utilized as storage systems comprised of multiple storage units. A method is widely known in the related art for forming disk array devices in groups of multiple storage units in a redundant storage structure to store the group data according to parity. In this way, when damage occurs such as a defective storage unit in a section of the group, the data saved in that storage system can be restored. Technology has also been disclosed in the related art in a first patent document (JP-A No. 148409/2000) for dual redundant storage of data to improve reliability by using a redundant storage structure.

This technology allows a higher probability of restoring data even when damage has simultaneously occurred in multiple sections within a group comprised of multiple storage units holding the original data for making the redundant data. When loading data, disk array devices utilizing this type of redundant structure must load the redundant data as well as the original data, and also verify that the loaded data is correct. This method requires more time for loading compared to devices not having a redundant structure. However, disk array devices usually have multiple storage units and controllers closely coupled at equal distances between those storage units for sending and receiving data. The transfer of data from any of the multiple storage units to the controllers takes approximately the same time to transfer. So, if a sufficient number of communication paths have been prepared for transferring data between any of the storage units and controllers, then more processing time is required in a redundant structure and time is also required for confirming that this data is correct.

Accordingly, distributed storage systems that incorporate multiple storage units in separate locations into one overall storage system also usually use a redundant structure the same as the disk array device. However, the multiple storage units and the controller sections that perform the sending and receiving of data between these multiple storage units in the distributed storage system are not always closely coupled at equal distances. Large differences may occur among the multiple storage units in the time required for data transfer and in the data transfer bandwidth especially when using communication paths such as the Internet rather than communication paths expressly for the distributed storage system. Consequently, in contrast to disk array controllers, when a redundant system having higher reliability is used, irregularities (or variations) may occur in the time required to transfer data from the multiple storage units to the controllers. These irregularities or variations increase the time required to load the data even further.

Data loading cannot be completed until all data has been received from all of the multiple storage units. Data transfer time is therefore determined by the largest amount of time needed to transfer data from any of the multiple storage units to the controller.

### SUMMARY OF THE INVENTION

The present invention has the object of eliminating the problem of the ever increasing data loading time inherent in distributed storage systems due to irregularities in the time required to transfer data from one of the storage devices, as well as the increased loading time occurring due to verifying correct data with redundant data. The present invention has the further object of providing a distributed storage system capable of high speed data loading while suppressing increases in the time needed to load data and maintaining the reliability of the stored data by a redundant structure.

When storing data within multiple storage units, one embodiment involves storing dual-redundant data in the direction of each storage unit and a direction spanning multiple storage units. When loading data from the multiple storage units, one embodiment involves utilizing redundant data in a direction spanning the multiple storage units to restore the data at the point that data has arrived from the remaining storage units except for one storage unit, without waiting for transfer of the remaining data, and completing the loading of data.

These and other characteristics of the present invention will become apparent in the description of the embodiments. It should be appreciated that the present invention can be implemented in numerous ways, including as a process, an apparatus, a system, a device or a method, which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a schematic diagram showing the overall structure of the computer system, in accordance with one embodiment of the present invention.

FIG. 2 is a flowchart showing the processing flow within the storage controller when saving data into the distributed storage system, in accordance with one embodiment of the present invention.

FIG. 3 is a schematic diagram showing processing of 64 byte size data within the storage controller 6 when saving data into the distributed storage system of the embodiment described in FIG. 2, in accordance with one embodiment of the present invention.

FIG. 4 is a schematic diagram showing the processing flow in the storage controller when loading data from the distributed storage system, in accordance with one embodiment of the present invention.

FIG. 5 is a schematic diagram that shows how a bit error of one bit has occurred in the 9 byte data of bits 64 through bit 127+ECCO through ECC7 loaded from storage #2, in accordance with one embodiment of the present invention.

FIG. 6 is a schematic diagram that shows in detail a method for restoring the storage #6 data, in accordance with one embodiment of the present invention.

FIG. 7 is a graph showing the effect of the control method for a distributed storage system, in accordance with one embodiment of the present invention.

### DESCRIPTION OF THE PREFERRED EMBODIMENTS

An invention for a method and system for controlling a distributed storage system is disclosed. Numerous specific details are set forth in order to provide a thorough understanding of the present invention. It will be understood, however, to one skilled in the art, that the present invention may be practiced without some or all of these specific details.

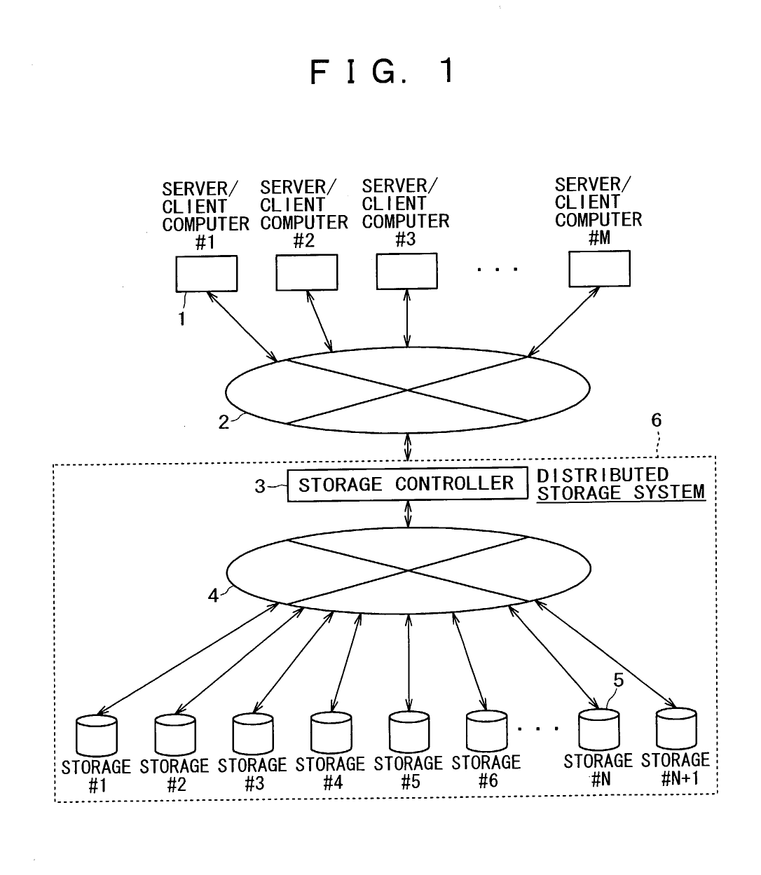

FIG. 1 is a schematic diagram showing the overall structure of the computer system, in accordance with one embodiment of the present invention. A distributed storage system 6 is comprised of multiple storage devices 5, storage controllers 3, and a communication path 4 connecting these devices 5 and controllers 3. This storage system 6 is connected by a communication path 2 to a server computer or to a client computer 1, etc. The storage controller 3 saves data in the storage device 5 and loads data from the storage device according to the request from the server/client computer 1. The data storage methods and loading methods that are characteristic (unique to) of the present invention are implemented by data processing performed by the storage controller.

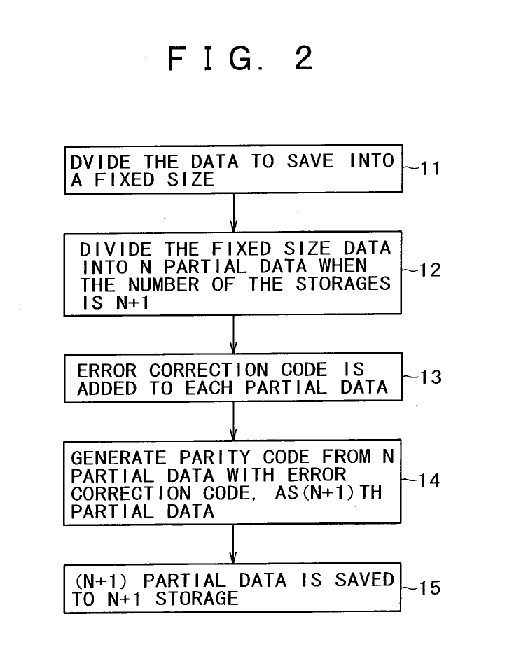

FIG. 2 is a flowchart showing the processing flow within the storage controller 3 when saving data into the distributed storage system 6, in accordance with one embodiment of the present invention. The storage controller 3 divides up-data according to the number of storage units for storing fixed size data (step 11). When the number of storage units at the destination for storing the data is N+1, the data is divided up into N units, which is called partial data (step 12).

Redundant data is next added for error correction of the respective N pieces of partial data. This redundant data allows error correction of the individual pieces of partial data. This redundant data also allows data with errors from the storage unit or communication path to be restored back to the original partial data (step 13).

Redundant data is then generated for correcting errors in the N pieces of partial data that were attached with redundant data (step 14). This data is called redundant partial data. If even one of the N pieces of partial data with-redundant-data is missing, this redundant partial data can restore that missing partial data-with-redundant-data back to its original state.

Finally, the N pieces of partial data that were generated and 1 piece of redundant partial data are totaled as (N+1) partial data, and this (N+1) partial data is sent to the storage devices (N+1 storage) and saved (step 15).

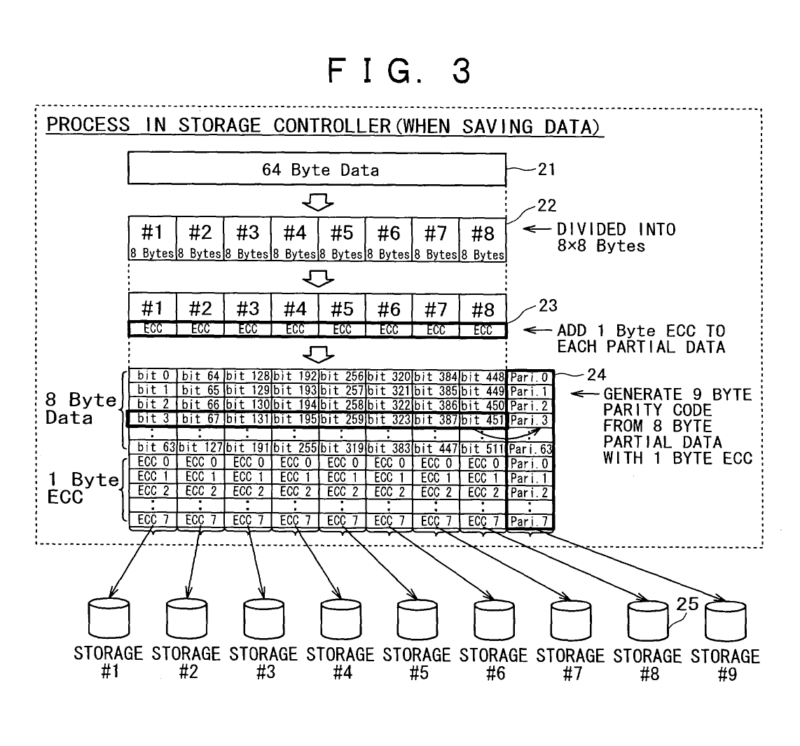

FIG. 3 is a schematic diagram showing processing of 64 byte size data within the storage controller 6 when saving data into the distributed storage system of the embodiment described in FIG. 2, in accordance with one embodiment of the present invention. In the example in FIG. 3, there are 9 storage units so the 64 byte data 21 is divided up into eight pieces with each piece of partial data consisting of eight bytes. Next, one byte of ECC (error correcting code) 23 capable of correcting a one bit error is added as redundant (error correcting) data to the eight pieces of 8 byte partial data 22 for a total of nine bytes of partial data with error correction code. A parity (bit) 24 is then generated for each bit of these eight pieces of 9 bytes of partial data 22. For example, one parity bit (in FIG. 3 is Pari. 0) is generated for the beginning eight bits (In FIG. 3, bits 0, 64, 128, 192, 256, 320, 384, 448). The accumulated parity bits have a size of nine bytes the same as the nine bytes of error-correcting partial data. This processing generates nine pieces of 9 byte data and these nine pieces of data are each transferred to the nine storage units and saved. The transfer of one of the nine pieces of data to a storage unit may be delayed more than the other pieces of data. This delay allows the original data to be restored by arranging data from the eight storage units so that data can be saved in cases when the communication path between the storage controller and the storage unit is congested or when other priority data is transferred or data storage at the storage destination is temporarily congested or has stopped.

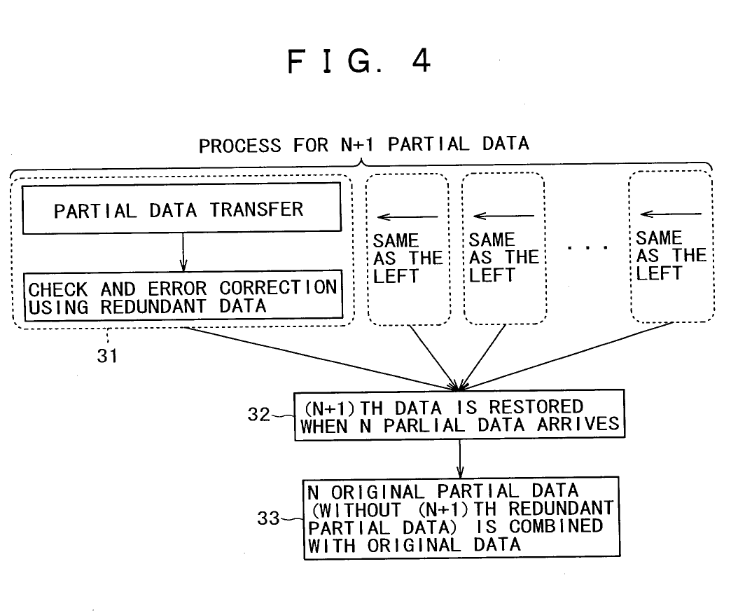

FIG. 4 is a schematic diagram showing the processing flow in the storage controller when loading data from the distributed storage system, in accordance with one embodiment of the present invention. The partial data saved in each storage unit is first of all loaded and sent. The redundant data (error correction code) is then used to check whether the partial data is correct. When an error is found in the partial data that was sent, error correction is performed using the redundant data (error correction code). This processing can be implemented in parallel since it is performed in each distributed storage unit (step 31). Data is next collected from each storage unit and at the point that all data except for one piece has arrived, that piece of data is restored by the redundant data (error correction code) added when the remaining one piece of data was saved (step 32). In other words, during loading of data stored in the N+1th storage unit from among N storage units, the data for loading from the one remaining storage unit is restored at the point that accuracy check or error correction of data as described in step 31 is completed. When the first arriving data from the Nth storage unit is all partial data having N pieces of redundant data generated during saving, the data from the one remaining storage unit is partial redundant data so there is no need to restore it.

However, when the first arriving data from the Nth storage unit is partial data with N−1 of redundant data and one piece of redundant partial data, then that one piece of redundant data must be restored: The redundant partial data generated during data saving has the capability to restore the remaining one piece of partial-data-with-redundant-data from among the partial-data-with N−1-of-redundant data. This remaining one piece of partial-data-with-redundant-data can therefore be restored.

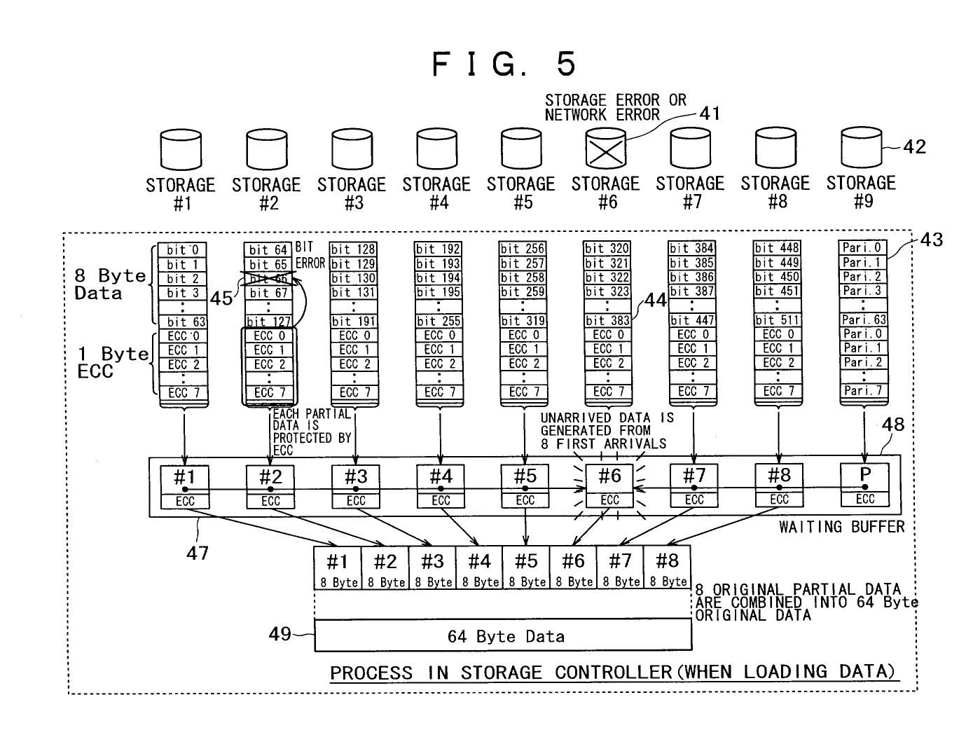

Finally, the partial data is combined with the original partial data (without N redundant data) and restored to the original data (step 33). FIG. 5 is a drawing showing the processing of 64 byte size data within the network storage controller when loading data from the distributed storage system of the embodiment described in FIG. 4. This example shows the processing when loading 64 byte data saved by the method shown in FIG. 3. The example in FIG. 5, has 9 storage units (41, 42) the same as in FIG. 3, and in eight of these storage units (storage #1 through #8) are 9 byte partial data-with-redundant-data, and one storage unit (storage #9) stores 9 byte redundant partial data. Among these units, a bit error (45) of one bit has occurred in the 9 byte data of bits 64 through bit 127+ECCO through ECC7 loaded from storage #2 as shown in FIG. 5.

FIG. 5 is a schematic diagram that shows how a bit error (45) of one bit has occurred in the 9 byte data of bits 64 through bit 127+ECCO through ECC7 loaded from storage #2, in accordance with one embodiment of the present invention. One byte of ECC data contained in the 9 byte data from storage #2 corrects this bit error (45) and restores the correct data. Next, the data from storage #6 (41) is delayed in arriving at the storage controller 48 due to storage problems or communication delays, etc. The data from all of the storage units except for storage #6 (41) therefore arrives at the waiting buffer (47) within the storage controller 48. Data loaded from storage #6 (41) is restored from among the eight pieces of 9 byte data that arrived at the storage controller 48. Next, all the 8 byte partial data of the original data stored in storage #1 through storage #8 including the now restored data from storage #6 (41) are combined and restored to the original 64 byte data (49). The data loading process in the distributed storage system of the present invention was described above. Also, the data transfer traffic on the communication path between the storage #6 (41) and storage controller (48) can be reduced by notifying the storage #6 (41) that it can stop the loading process at the point that data can be restored by the above method.

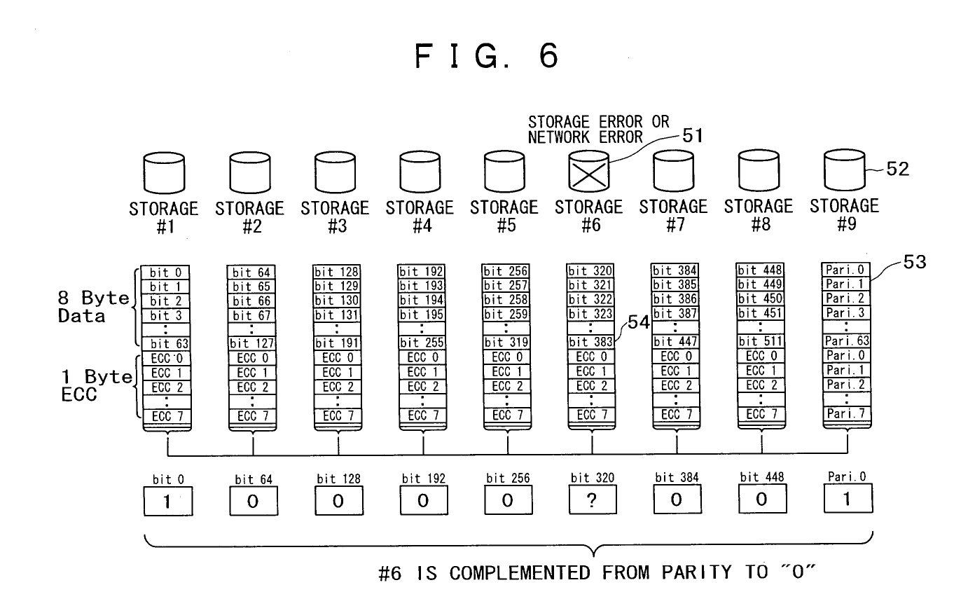

FIG. 6 is a schematic diagram that shows in detail a method for restoring the storage #6 (51) data, in accordance with one embodiment of the present invention. The example here describes restoring the first bit (bit 320) of data loaded from the storage #6 (51). In the example in FIG. 6, the bit Pari. 0 (53) of storage #9 (52) is the parity bit for the first bits of storage #1 through storage #5 and storage #7 through storage #9 (52). The parity of the first bits storage #1 through storage #8 (51, 52) must therefore be Pari. 0 (53). In the example in FIG. 6, except for storage #6 (51), the first bits of the storage #1 through storage #8 (bit 0, bit 64, bit 128, bit 192, bit 256, bit 384, bit 448) are respectively 1, 0, 0, 0, 0, 0, 0 and the parity bit Pari. 0 (53) is 1 so that the bit 320 (54) from the remaining storage #6 (51) is corrected to 0. Data from the storage #6 (51) can be restored by repeating this same processing for the following bits.

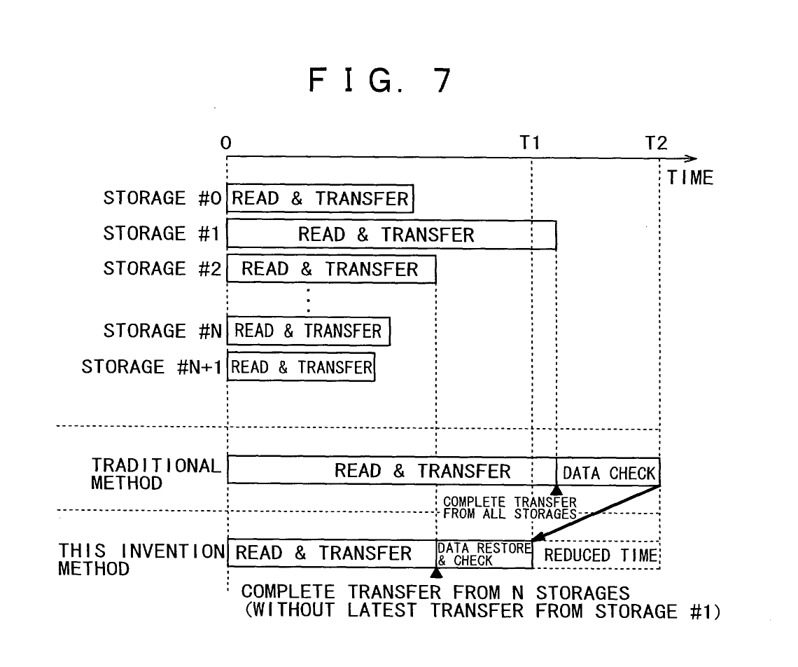

FIG. 7 is a graph showing the effect of the control method for a distributed storage system, in accordance with one embodiment of the present invention. The example in FIG. 7 is a bar graph showing towards the right-hand side the time required for loading and transferring, when loading (or reading) data from the N+1 storage (unit). In other words, the time required for loading and transferring is longest from storage #1 and the time required for loading and transferring from storage #2 is the next longest. In the related art in this case, a data check is made after transfer from all storage units is complete, and when loading of all data has finished the (total) processing time is T2. However in the method of the present invention, the checking and the restoring of data is performed at the point that the data arrived from N storage units without waiting for data from the slowest storage #1. In other words, data is checked and restored at the point that data arrives from the storage #2 and when all data loading ends the processing time is T1. The present invention therefore renders the effect of a shorter loading time (T2−T1).

In systems comprised of multiple storage units having a redundant structure, increases in data loading time might occur for example due to distributed storage systems where the communication paths between controllers and each storage unit installed at separate locations are at different distances or in insufficient numbers and badly affect the data transfer time from multiple storage units. In the present invention however when loading data from multiple storage units where data is stored by dual-redundancy, the data is restored (corrected) at the point that either of the redundant data has arrived, without waiting for transfer of the remaining data, and the loading of data is then completed. The present invention therefore renders that effect that increases in loading time are prevented while still maintaining redundancy and achieving high speed data loading.

System And Method Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, dividing the data to be saved into N sets of partial data, saving N sets of partial data as N stored partial data into the multiple storage units, and transferring the stored partial data, the transferring step including transferring stored partial data from all of the multiple storage units except one remaining storage unit, according to processes of the present invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A control method for a distributed storage system of data in multiple storage units, the control method comprising steps of:
dividing the data into N sets of partial data;
adding a first redundant data for error correction to each set of partial data;
generating a second redundant data for error correction as the (N+1)th set of partial data, the second partial data containing parity bits each generated from a corresponding data set of nth bits of said N sets of partial data;
saving said N sets of partial data and said (N+1)th set of partial data as stored partial data into the multiple storage units; and
transferring the stored partial data, the transferring step including transferring stored partial data from all of the multiple storage units except one remaining storage unit.

2. The control method of claim 1, further comprising steps of:
restoring the stored partial data of the one remaining storage unit using the second redundant data for error correction; and
combining N sets of partial data to complete transferring of data.

3. The control method of claim 1, further comprising the step of: when during transfer of stored partial data from the multiple storage units, when data to be transferred from the one remaining first storage unit is only the second redundant data for error correction, combining the N partial data without restoring the data to complete transfer of data.

4. A control method for a distributed storage system of data in multiple storage units, the control method comprising steps of:
dividing the data into N sets of partial data;
adding a first redundant data for error correction to each set of partial data;
generating a second redundant data for error correction as the (N+1)th set of partial data, the second partial data containing parity bits each generated from a corresponding data set of nth bits of said N sets of partial data;
saving said N sets of partial data and said (N+1)th set of partial data as stored partial data into the multiple storage units;
transferring the stored partial data from the multiple storage unit;
when during transfer of data, at the point that sets of partial data has arrived from all storage units except the one remaining storage unit, restoring the stored partial data of the one remaining storage unit using the second redundant data for error correction; and
combining N sets of partial data to complete transferring of data.

5. The control method of claim 4, further comprising the step of: when saving data into the multiple storage units, delaying saving of data into one storage unit.

6. The control method of claim 4, further comprising the step of: when during transfer of data, at the point that sets of partial data has arrived from all storage units except the one remaining storage unit, instructing the one remaining storage unit to stop data transfer.

7. A computer-readable medium carrying one or more sequences of one or more instructions for controlling a distributed storage system of data in multiple storage units, the one or more sequences of one or more instructions including instructions which, when executed by one or more processors, cause the one or more processors to perform the steps of:
dividing the data into N sets of partial data;
adding a first redundant data for error correction to each set of partial data, and
generating a second redundant data for error correction as the (N+1)th set of partial data, the second redundant data containing parity bits each generated from nth bits of said N sets of partial data;
saving said N sets of partial data and said (N+1)th set of partial data as stored partial data into the multiple storage units; and
transferring the stored partial data, the transferring step including transferring stored partial data from all of the multiple storage units except one remaining storage unit.

8. The computer-readable medium of claim 7, wherein the instructions further cause the one or more processors to carry out the steps of:
restoring the stored partial data of the one remaining storage unit using the second redundant data for error correction; and
combining N sets of partial data to complete transferring of data.

9. The computer-readable medium of claim 7, the instructions further cause the one or more processors to carry out the step of: when during transfer of stored partial data from the multiple storage units, when data to be transferred from the one remaining first storage unit is only the second redundant data for error correction, combining the N partial data without restoring the data to complete transfer of data.

10. A computer-readable medium carrying one or more sequences of one or more instructions for controlling a distributed storage system of data in multiple storage units, the one or more sequences of one or more instructions including instructions which, when executed by one or more processors, cause the one or more processors to perform the steps of:
dividing the data into N sets of partial data;
adding a first redundant data for error correction to each set of partial data, and
generating a second redundant data for error correction as the (N+1)th set of partial data, the second redundant data containing parity bits each generated from nth bits of said N sets of partial data;
saving said N sets of partial data and said (N+1)th set of partial data as stored partial data into the multiple storage units;
transferring the stored partial data from the multiple storage unit;
when during transfer of data, at the point that sets of partial data has arrived from all storage units except the one remaining storage unit, restoring the stored partial data of the one remaining storage unit using the second redundant data for error correction; and
combining N sets of partial data to complete transferring of data.

11. The computer-readable medium of claim 10, the instructions further causing the one or more processors to carry out the step of: when saving data into the multiple storage units, delaying saving of data into one storage unit.

12. The computer-readable medium of claim 10, the instructions further causing the one or more processors to carry out the step of: when during transfer of data, at the point that sets of partial data has arrived from all storage units except the one remaining storage unit, notifying the one remaining storage unit to stop data transfer.
